(19) United States
(12) Patent Application Publication
(10) Pub. No.: US 2009/0137245 A1
(43) Pub. Date: May 28, 2009

(54) Monitoring Network Access of Roaming Users

(76) Inventors: Anthony Richardson, Gloucestershire (GB); David Edwards, Gwent (GB)

Correspondence Address: NIXON & VANDERHYE, PC, 901 NORTH GLEBE ROAD, 11TH FLOOR, ARLINGTON, VA, 22203, US

(21) Appl. No.: 11/884,144

(22) PCT Filed: Feb. 3, 2006
(86) PCT No.: PCT/GB06/00373

§ 371 Date: Jun. 23, 2008

(30) Foreign Application Priority Data
Feb. 10, 2005 (GB) 0502780.0

(51) Int. Cl. H04W 60/00

(52) U.S. Cl. 455/433

(57) ABSTRACT

There is provided a method of monitoring access to a set of mobile communication networks, the method comprising: placing a testing device within the coverage area of a plurality of mobile communication networks, the plurality of mobile communication networks forming a set of mobile communication networks, the testing device comprising a network authentication device for a mobile communication network not in the set of mobile communication networks; initiating a succession of network registration procedures from the testing device; and storing, in the testing device, the identity of the mobile communication network that the testing device registers with as a result of each network registration procedure.

### TECHNICAL FIELD OF THE INVENTION

The invention relates to a method and apparatus for monitoring access to a set of mobile communication networks, and in particular relates to a method and apparatus for monitoring access by roaming users to a set of mobile communication networks.

### BACKGROUND TO THE INVENTION

A mobile telephone user usually subscribes to a service from one particular mobile network operator. When the user leaves the coverage area of their network, the user is described as “roaming”. In order for the user to continue to receive a mobile telephone service whilst roaming, the user's mobile telephone will temporarily register with a local network provider until the user returns to an area covered by their network.

In order for this roaming service to be provided, the user's network provider must have a roaming agreement with other networks covering areas that a user might temporarily visit. If the user's network provider does not have a roaming agreement with any of the networks that are local to the roaming user, no service will be provided to the roaming user.

Roaming most often occurs when a user travels to another country, but it can also occur if the network that the user subscribes to has a limited coverage area in a particular country.

As roaming services provided by a network operator can be a valuable source of revenue, it is desirable for a network operator to be able to ensure that roaming users are able to successfully gain access to their network, and that, once registered, the roaming users are able to successfully place and receive voice calls and access other network services, such as voice mail. It is also desirable to determine whether roaming users are more likely to gain access to their network or the networks of other network operators.

### SUMMARY OF THE INVENTION

According to a first aspect of the invention, there is provided a method of monitoring access to a set of mobile communication networks, the method comprising: placing a testing device within the coverage area of a plurality of mobile communication networks, the plurality of mobile communication networks forming a set of mobile communication networks, the testing device comprising a network authentication device for a mobile communication network not in the set of mobile communication networks; initiating a succession of network registration procedures from the testing device; and storing, in the testing device, the identity of the mobile communication network that the testing device registers with as a result of each network registration procedure.

According to a second aspect of the invention, there is provided a testing device for monitoring access to a set of mobile communication networks, the device comprising: means for retaining a network authentication device for a mobile communication network; means for initiating a succession of network registration procedures; and means for storing the identity of the mobile communication network that the testing device registers with in response to each network registration procedure.

### BRIEF DESCRIPTION OF THE DRAWINGS

For a better understanding of the invention, and to show more clearly how it may be carried into effect, reference will now be made, by way of example, to the following drawings, in which:

FIG. 1 is a diagram showing a testing device according to the invention in the coverage area of a plurality of mobile communication networks;

FIG. 2 is a block diagram of a testing device in accordance with the invention; and

FIG. 3 is a flow chart of the method of monitoring access to a set of mobile communication networks in accordance with the invention.

### DETAILED DESCRIPTION OF THE PREFERRED EMBODIMENTS

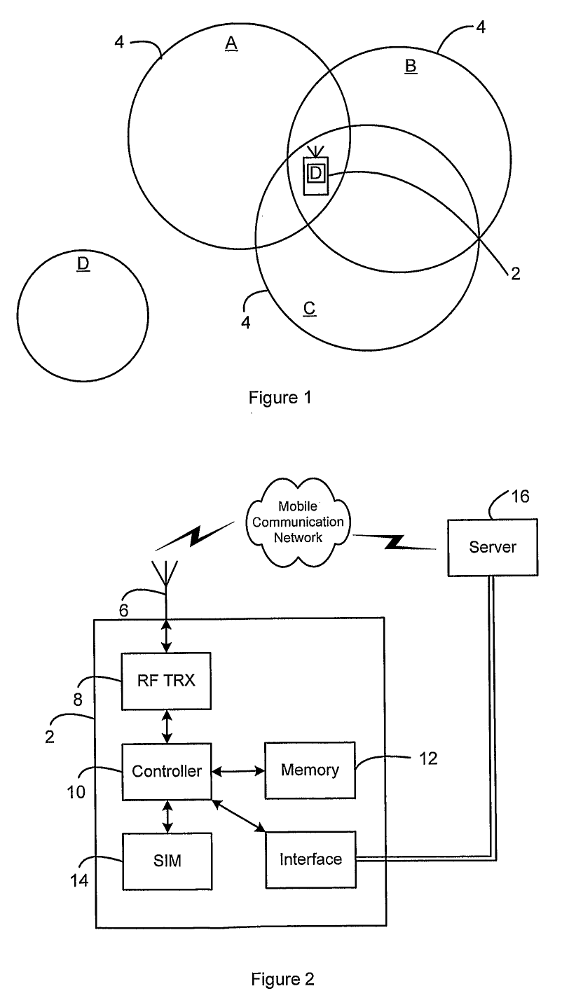

FIG. 1 shows a testing device 2 in accordance with the invention placed in the coverage area of a plurality of mobile communication networks.

Although the invention will be described below with reference to measuring access to the networks of different network operators, it will be appreciated that the invention is also applicable to measuring access to the networks of different service providers on a particular network.

In this illustrated example, the testing device 2 is placed in a location covered by three networks, network A, network B and network C. Each of these networks has a coverage area indicated by a respective boundary line 4. In FIG. 1, these coverage areas are shown as largely distinct from each other, for ease of illustration. However, in practice, the coverage areas of the networks A, B, C may largely, or completely, overlap. As indicated above, networks A, B and C can be (i) each operated by different network operators, (ii) each operated by different service providers on a network provided by a single network operator, or (iii) a combination of (i) and (ii).

The network or networks may be any type of mobile communications networks, including GSM, EDGE, GPRS or 3G networks.

FIG. 2 shows a testing device in accordance with the invention. The testing device 2 comprises an antenna 6 connected to radio transceiver circuitry 8 for transmitting and receiving signals over the networks A, B, C. The transceiver circuitry 8 is connected to a controller 10 which controls the operation of the testing device 2. A memory 12 is provided which is capable of storing measurements obtained by the testing device 2. The testing device 2 also comprises a network authentication device 14 for a network D, whose coverage area does not extend to the location in which the testing device 2 is placed.

If the testing device 2 is to be placed in the coverage areas of networks A, B, C that use different communication technologies, for example CDMA or TDMA, or different frequency ranges, the transceiver circuitry 8 of the testing device 2 can be adapted for communicating using each of the different technologies or frequencies.

As mentioned above, the testing device 2 is placed in the coverage area of each of a number of networks A, B, C. Preferably, the testing device 2 is placed in a geographical location in which conventional mobile units regularly attempt to, obtain a temporary registration with one of the local networks A, B, C.

For example, suitable locations could be a port or an airport, or any location that is considered to be an ‘entry point’ to the local networks A, B, C. An ‘entry point’ does not necessarily have to be at the geographical edge of a particular network.

Preferably, the testing device 2 remains in a fixed location in the coverage area of all of the networks A, B, C. Alternatively, the testing device 2 may be allowed to move within this coverage area. For example, the testing device 2 may be mounted on a vehicle, or carried by a person. When the testing device 2 is allowed to move within the coverage area of the networks, the testing device 2 may be provided with a position measurement system (not shown), such as GPS.

In order to allow a network operator to monitor network access by roaming users, the testing device 2 is adapted to make a succession of network registration requests to the local networks (networks A, B and C in FIG. 1) using the user profile stored in the network authentication device 14. This network authentication device 14 is a SIM card in the preferred embodiment of the invention. Specifically, where the invention is intended for deployment in, for example, a first country such as the United Kingdom, the SIM card is advantageously issued by a network operator in a second country, such as France.

In a preferred embodiment of the invention, the testing device 2 is adapted to act as though it is a mobile unit that has just been activated in the coverage area of the local networks (networks A, B and C in FIG. 1). Therefore, the testing device 2 initially searches for all available networks.

Once the testing device 2 has searched for all available networks, the testing device 2 must identify a network from the available networks with which to obtain a temporarily registration. This network will be referred to as a candidate network. To do this, the network authentication device 14 advantageously includes a list of preferred networks that are arranged in a particular order.

The network operator that originally supplied the network authentication device 14 will usually have pre-programmed this order into the device 14, but it is also possible for a user of the device in which the network authentication device 14 is located to change the order according to personal preference.

If the testing device 2 is unable to identify or detect any of the networks on the list of preferred networks in the local area, the testing device 2 will choose a candidate network from the networks that the testing device 2 has been able to detect. The testing device 2 may select the candidate network from the detected networks on the basis of the network with the highest received signal strength, or, alternatively, the testing device 2 may select the candidate network randomly from any of the detected networks that have a received signal strength above a predetermined threshold.

For example, the testing device 2 in FIG. 1 may not have any of local networks A, B or C listed on its network authentication device. Therefore, the testing device 2 may select a candidate network by determining which of the local networks A, B or C have the highest received signal strength, or by randomly selecting from the networks that have a received signal strength above a threshold.

Once the candidate network has been identified, the testing device 2 must send a request to register with the candidate network.

The registration procedure will be further described with reference to the procedure performed in a GSM network, although the invention is not limited to the described procedure, or GSM networks.

In a GSM network, the registration procedure begins with a Location Update procedure. The testing device 2 uses an International Mobile Subscriber Identity (IMSI), stored on the SIM card 14 to identify itself to the candidate network. The candidate network uses the IMSI to identify the originating network of the SIM card 14 (i.e. the network that issued the SIM card 14).

The originating network will then determine whether the SIM card 14 has the right to use the candidate network. If it is determined that the SIM card 14 does have the right to use the candidate network, the originating network sends an Insert Subscriber Data message to the candidate network. The candidate network then uses the information in this message to authenticate the testing device 2 and determine its network service settings.

The candidate network then sends a Mobile Station Roaming Number (MSRN) to the originating network. The MSRN is a temporary number that is used to identify the testing device 2 whilst it is registered with the candidate network.

The procedure described above will be used by the testing device 2 to determine the first network in the set of local networks (networks A, B and C) that the testing device should attempt to register with.

After the first registration is completed, the testing device 2 may attempt to register with a different candidate network in the set of local networks. The testing device 2 may select the next network on the list of preferred networks stored on the network authentication device 14 as the next candidate network, or alternatively, the testing device 2 may select the network with the next highest received signal strength.

In addition, the testing device 2 can be adapted to repeat the search for all available networks before starting the network registration procedure. This allows the testing device 2 to initiate the network registration procedure using an up to date list of the local networks. This is particularly important where the testing device 2 is free to move, for example where it is mounted on a vehicle, as the particular local networks detectable by the testing device 2 and their received signal strengths will change over time.

When the testing device 2 has registered with one of the local networks, the testing device 2 identifies the network that has responded and temporarily stores the identity in the memory 12. The testing device 2 can also detect the type and quality of services available to the testing device 2 over the temporary network. For example, the testing device 2 can place a voice call over the network and measure various quality parameters associated with the call. In addition, the testing device 2 can determine whether it is possible to access a voicemail service associated with the network authentication device 14. The availability of other types of network services, such as SMS, MMS or GPRS can also be tested.

The testing device 2 can also measure and store the characteristics, such as the received signal strength or number of neighbouring cells, for each network detected during the network search stage.

After registering with a succession of local networks and storing the results in the memory 12, the testing device 2 will upload the results to a remote server 16. The remote server 16 can advantageously be controlled by the operator of one of the networks A, B, C. That network operator can then analyse the uploaded results, and results received from any other testing devices 2 placed in the coverage area of the networks, to determine whether roaming users are able to gain access to their specific network, and to estimate the distribution of roaming user registrations between the different local networks, that is, between its own network and its competitors' networks.

Where, as above, the testing device 2 is deployed in a first country and contains a SIM card issued in a second country, this allows the network operator in the first country to simulate the experiences of visitors from the second country.

The results obtained by the testing device or devices 2 can be uploaded to the server 16, using any techniques known in the art. For example, the results can be uploaded via the mobile network of the operator (i.e. either network A, B or C) or may be uploaded via a fixed line connection to the server 16. In this latter embodiment, the testing device 2 will be provided with an interface 18 for connecting the testing device 2 to the fixed line. However, it will be appreciated that any other type of wired or wireless connections between the testing device 2 and the server 16 may be used to upload the results to the server 16.

The results can be uploaded after a specified number of registrations have been conducted, or after a predetermined length of time has elapsed.

If the testing device 2 is allowed to move within the coverage area of the local networks and is provided with a position measurement system, the position of the testing device 2 can be measured at the time that each access request is sent to the local networks. The position measurements can then be uploaded to the server 16 in order to allow the network operator to determine whether there are any areas of their network where roaming users are unable to obtain a registration with their network, or whether there are areas where a roaming user is much more likely to obtain a registration with a competitor's network.

As the network authentication device 14 may have an effect on the particular local network with which the testing device 2 registers, the testing device 2 may be provided with network authentication devices for a number of different networks whose coverage areas do not extend to the location in which the testing device 2 is placed. The testing device 2 can then initiate a succession of network registration procedures using the user profiles stored on each of the network authentication devices 14 in the testing device 2.

Alternatively, multiple testing devices 2 can be placed in similar locations within the coverage area of the networks, with each testing device 2 having a network authentication device for a respective network whose coverage area does not extend to the location in which the testing device 2 is placed.

The server 16 may download instructions to the testing device 2 in order to control the operation of the testing device 2. For example, these instructions may relate to the frequency with which to initiate the network registration procedure, the signal strength to be used in the procedure, the network authentication device 14 to be used (if the testing device is provided with a number of network authentication devices 14), the frequency with which results should be uploaded to the server 16, the frequency at which to search for available networks, or the type of network services that the testing device 2 should monitor.

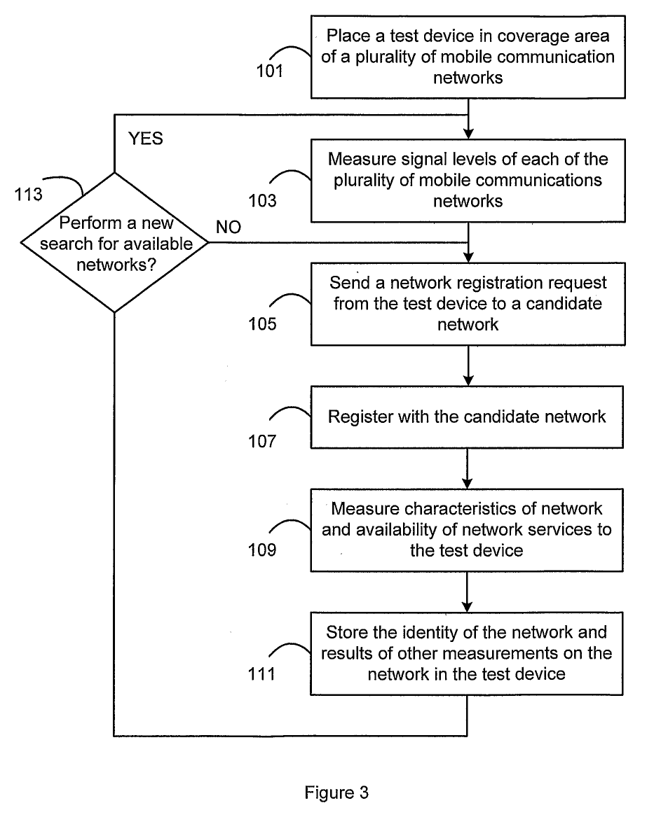

FIG. 3 is a flow chart of the method of monitoring access to a set of mobile communication networks in accordance with the invention.

In step 101 the method comprises placing a testing device in the coverage area of a plurality of mobile communication networks.

In step 103, the testing device measures the signal levels of the plurality of mobile communication networks to determine which networks are available for roaming users to register with.

In step 105, the testing device selects a candidate network from the available networks as described above, and sends a network registration request to the selected candidate network. The testing device may be configured to select the candidate network based on instructions stored in its memory, or based on instructions provided by a remote server.

In step 107, the testing device registers with the candidate network, provided that the user profile stored on the network authentication device allows for roaming in the selected candidate network.

In step 109, the testing device measures various characteristics of the network with which it is registered, and, if required, tests the availability and quality of various network services.

In step 111, the identity of the network that the testing device registered with is stored in the testing device, along with the results of any measurements performed in step 109. The testing device may also store the results of the search for available networks performed in step 103, including the identity of the networks and their signal strengths.

In step 113, it is determined whether to perform a new search for available networks. If a new search is to be performed, the method passes back to step 103. If it is not necessary to carry out a new search for available networks yet, the method passes back to step 105 and the testing device attempts to register with a different network.

The testing device therefore initiates a succession of network registration procedures. These can follow immediately one after the other, or can be spaced apart in time.

There is therefore provided a method and system for allowing a network operator to determine whether roaming users are able to successfully gain access to their network, and whether, once registered, the roaming users are able to successfully place and receive voice calls and access other network services, such as voice mail.

1. A method of monitoring access to a set of mobile communication networks, the method comprising:
placing a testing device within the coverage area of a plurality of mobile communication networks, the plurality of mobile communication networks forming a set of mobile communication networks, the testing device comprising a network authentication device for a mobile communication network not in the set of mobile communication networks;
initiating a succession of network registration procedures from the testing device; and
storing, in the testing device, the identity of the mobile communication network that the testing device registers with as a result of each network registration procedure.

2. A method as claimed in claim 1, wherein the testing device is placed at a fixed location within the coverage area of the plurality of mobile communication networks.

3. A method as claimed in claim 2, wherein the testing device is placed at an airport or port.

4. A method as claimed in claim 1, wherein the testing device is free to move within the coverage area of the plurality of mobile communication networks.

5. A method as claimed in claim 1, wherein the method further comprises measuring a position of the testing device at or about the time when each network registration procedure is initiated by the testing device.

6. A method as claimed in claim 1, further comprising the step of transmitting the stored identity or identities to a remote server.

7. A method as claimed in claim 1, wherein the testing device comprises a network authentication device for each of two or more mobile communication networks not in the set of mobile communication networks, and the step of initiating a succession of network registration procedures comprises initiating each network registration procedure using one of the network authentication devices in the testing device.

8. A method as claimed in claim 1, wherein the step of initiating comprises the steps of:
searching for available mobile communication networks by measuring the signal strengths of the plurality of mobile communication networks;
selecting a candidate mobile communication network from the available mobile communication networks on the basis of the measured signal strengths; and
sending a network registration request to the candidate mobile communication network.

9. A method as claimed in claim 8, wherein the step of selecting a candidate mobile communication network comprises selecting the mobile communication network having the highest signal strength.

10. A method as claimed in claim 8, wherein the step of selecting a candidate mobile communication network comprises randomly selecting, the candidate mobile communication network from the available mobile communication networks that have a measured signal strength above a predetermined threshold.

11. A method as claimed in claim 8, wherein the network authentication device has a list of preferred mobile communication networks stored therein, and the step of selecting a candidate mobile communication network comprises selecting a mobile communication network measured during the step of searching that is on the list of preferred mobile communication networks.

12. A method as claimed in claim 1, further comprising, after the step of initiating:
measuring the availability of network services on the mobile communication network that the testing device is registered with.

13. A method as claimed in claim 1, further comprising, after the step of initiating:
measuring, the quality of network services on the mobile communication network that the testing device is registered with.

14. A testing device for monitoring access to a set of mobile communication networks, the device comprising:
means for retaining a network authentication device for a mobile communication network;
means for initiating a succession of network registration procedures; and
means for storing the identity of the mobile communication network that the testing device registers with in response to each network registration procedure.

15. A testing device as claimed in claim 14, further comprising a position measurement system that is adapted to measure the position of the testing device at or about the time that the means for initiating initiates a network registration procedure.

16. A testing device as claimed in claim 14, further comprising means for transmitting the stored identities to a remote server.

17. A testing device as claimed in claim 14, wherein the means for retaining a network authentication device is further adapted to retain a plurality of network authentication devices, and wherein, in use, the means for initiating a succession of network registration procedures is adapted to select one of the network authentication devices retained in the testing device for use in each network registration procedure.
